(19) United States
(12) Patent Application Publication
(10) Pub. No.: US 2026/0349488 A1
(43) Pub. Date: Nov. 5, 2026

(54) Power Supplies for Compute Cores

(71) Applicant: Google LLC, Mountain View, CA (US)

(72) Inventor: Juha Joonas Oikarinen, Mountain View, CA (US)

(73) Assignee: Google LLC, Mountain View, CA (US)

(21) Appl. No.: 19/102,803

(22) PCT Filed: Oct. 6, 2022
(86) PCT No.: PCT/US2022/045848

§ 371 Date: Feb. 10, 2025

(51) Int. Cl. G06F 1/26; H02M 3/155

(52) U.S. Cl. CPC G06F 1/263; H02M 3/155

(57) ABSTRACT

This document describes power supplies for compute cores. In one aspect, a power supply system for a compute core includes a primary power converter configured to provide and regulate direct current (DC) power to the compute core over a power rail that electrically couples an output of the primary power converter to the compute core. The power supply system also includes a transient suppressor circuit coupled to the power rail and configured to suppress transient voltage differences between a target supply voltage for the compute core and an actual supply voltage to the compute core.

### TECHNICAL FIELD

This specification relates to power supplies for compute cores.

### BACKGROUND

Power management integrated circuits (PMICs) are integrated circuits (IC) that provide power management for other circuits, such as compute cores. PMICs can provide various power management functions, such as power conversion, voltage regulation, and directionality of power flow.

### SUMMARY

This document describes power supply topologies for compute cores. When high performance compute cores are supplied with board mounted PMICs, the loop bandwidth is limited due to an RLC filter formed by the package and parasitic inductance, parasitic resistance, and decoupling capacitance. To compensate for the voltage drops due to these parasitics, the power converter of the PMIC that provides power to the compute core is often set to output a higher than necessary output voltage resulting in additional power losses. These losses can amount to, for example, 5-15% of total power loss in the system. The higher output voltage also results in higher temperatures.

Some cores include on-die droop mitigation functionality that compensates for voltage drops that occur when the core's load increases. This droop mitigation can include reducing the clock cycle of the core and/or delaying instructions until the voltage supplied to the core returns to an acceptable or target level. If droop mitigation is applied, the voltage error seen by the PMIC is reduced and the system has a tendency to stay in the mitigation state longer than optimal, which negatively impacts the performance of the core.

The power supply topologies described in this document include a primary power converter, which can be implemented as a PMIC, and a transient suppressor circuit. The primary power converter is configured to provide the supply power to the core. For example, the primary power converter can provide the total amount of direct current (DC) power that is consumed by the core during any normal load conditions of the core. The transient suppressor circuit is configured to suppress transient deviations between the target supply voltage to the core and the actual input voltage to the core. These deviations often occur when the core transitions between different load levels (e.g., from a low load level to a high load level and vice versa) and when the core transitions between different target supply voltages for the core. For example, PMICs often overshoot the target supply voltage when transitioning from a lower target supply voltage to a higher target supply voltage.

The transient suppressor circuit is configured to provide additional current and/or remove electrical charge from the power rail that supplies power to the core to quickly mitigate differences between the target supply voltage and the actual input voltage to the core. The transient suppressor circuit can include a power converter that operates at a higher frequency than the primary power converter so that the transient suppressor circuit can act fast to reduce the voltage difference until the primary converter can compensate for the voltage difference. To reduce the voltage differences, the transient suppressor circuit can be configured to selectively supply or remove electrical charge from the power rail when the rate of change of the actual input voltage to the core is high, e.g., greater than a threshold. This also enables the transient suppressor circuit to regulate the rate of change of the input voltage, which results in smaller overshoots and undershoots, faster transitions between target supply voltage levels, and reduced time in states in which the voltage difference is higher than desired.

The transient suppressor circuit can be configured to signal to the primary converter when the circuit is actively injecting or removing electrical charge from the power rail. This informs the primary power converter that it needs to compensate for a voltage difference so that the primary can adjust its output voltage. In this way, the amount of time that the transient suppressor circuit injects or removes electrical charge from the power rail is reduced. For example, absent such signaling it would take longer for the primary power converter to detect that the primary power converter is not providing an appropriate voltage level to the core. Similarly, the transient suppressor circuit can signal to the primary power converter when the on-die droop mitigation is active so that the primary power converter can increase its output voltage so that the droop mitigation is no longer needed. This reduces the amount of time droop mitigation is active relative to power supplies that do not include the transient suppressor circuit, thereby increasing the performance of the core.

In general, one innovative aspect of the subject matter described in this specification can be embodied in power supply systems that include a primary power converter configured to provide and regulate direct current (DC) power to the compute core over a power rail that electrically couples an output of the primary power converter to the compute core; and a transient suppressor circuit coupled to the power rail and configured to suppress transient voltage differences between a target supply voltage for the compute core and an actual supply voltage to the compute core. Other embodiments of this aspect include corresponding apparatus, methods, and computer programs, configured to perform the actions of the methods, encoded on computer storage devices.

These and other implementations can each optionally include one or more of the following features. In some aspects, the transient suppressor circuit includes an additional power converter configured to selectively inject electrical charge onto one or more capacitors coupled to the power rail based on the transient voltage differences. The transient suppressor circuit can include a hysteretic control loop comprising a rate of change controller that regulates a rate of change of the actual supply voltage to the compute core. The rate of change controller can include multiple modes including a disable mode in which the rate of change controller is disabled when the primary power converter is actively increasing or decreasing the actual supply voltage based on a workload of the compute core. The power converter can include a buck converter.

In some aspects, the transient suppressor circuit includes a signal adjustment circuit configured to adjust a voltage signal that represents the actual supply voltage and provide the adjusted voltage signal to the primary power converter. The primary power converter can be configured to adjust the DC power to the compute core based on an error that represents a difference between the target supply voltage and the adjusted voltage signal.

In some aspects, the transient suppressor circuit includes a combiner circuit configured to generate the adjusted voltage signal based an output current of the transient suppressor circuit injected onto or removed from the power rail by the transient suppressor circuit. The transient suppressor circuit can include a combiner circuit configured to generate the adjusted voltage signal based on an error signal received from the compute core. The error signal can indicate whether a droop mitigator of the compute core is mitigating a voltage droop of the compute core.

In some aspects, the transient suppressor circuit is physically located closer to the compute core than the primary power converter. In some aspects, a control loop of the transient suppressor circuit is faster and has a higher bandwidth than a control loop of the primary power converter.

In general, another innovative aspect of the subject matter described in this specification can be embodied in methods that include the operations of providing, by a primary converter, direct current (DC) power to the power core over a power rail that electrically couples an output of the primary power converter to the compute core; regulating, by the primary power converter, a voltage level of the power rail; detecting, by a transient suppressor circuit electrically couple to the power rail, a transient voltage difference between a target supply voltage for the compute core and the voltage level of the power rail; and selectively adjusting, by the transient suppressor circuit, the voltage level of the power rail by injecting electrical charge or removing electrical charge from one or more capacitors electrically coupled to the power rail. Other embodiments of this aspect include corresponding systems, apparatus, and computer programs, configured to perform the actions of the methods, encoded on computer storage devices.

These and other implementations can each optionally include one or more of the following features. In some aspects, detecting the transient voltage difference includes detecting, by a rate of change controller of the transient suppressor circuit, a rate of change of the voltage level of the power rail and determining that the rate of charge satisfies a threshold rate of change.

Some aspects include receiving a mode signal indicating that the primary power converter is actively increasing or decreasing the actual supply voltage based on a workload of the compute core and disabling the rate of change controller in response to receiving the mode signal.

Some aspects include adjusting, by a signal adjustment circuit of the transient suppressor circuit, a voltage signal that represents the actual supply voltage and providing, by the signal adjustment circuit, the adjusted voltage signal to the primary power converter.

Some aspects include adjusting, by the primary power converter, the DC power to the compute core based on an error that represents a difference between the target supply voltage and the adjusted voltage signal.

Some aspects include generating, by a combiner circuit of the transient suppressor circuit, the adjusted voltage signal based an output current of the transient suppressor circuit injected onto or removed from the power rail by the transient suppressor circuit.

Some aspects include generating, by a combiner circuit of the transient suppressor circuit, the adjusted voltage signal based on an error signal received from the compute core. The error signal can indicate whether a droop mitigator of the compute core is mitigating a voltage droop of the compute core.

Particular embodiments of the subject matter described in this specification can be implemented so as to realize one or more of the following advantages. The power supply topologies that include a primary power converter and a transient suppressor circuit that both regulate the voltage of a power rail for a core provides faster digital voltage scaling (DVS) transitions (e.g., transitions between different target supply voltage levels), while also reducing overshoots (e.g., passing an increased target supply voltage level) and undershoots (e.g., passing a reduced target supply voltage level) that occur during these voltage level transitions and also during load level transitions. This results in improved energy efficiency due to shorter transition times and less time above or below the target supply voltage, and also improved core performance as faster transitions to higher voltages enables the core to more quickly respond to higher load levels. The increased speed of transitions also reduces the amount of time spent at higher operating points for the core, which reduces total power consumption and therefore further improves energy efficiency.

The transient suppressor circuit also enables the primary power converter to operate at a lower output voltage without negatively impacting core performance. PMICs often operate at a higher voltage, e.g., at around 15% higher voltage to prevent the actual supply voltage from excessive droop that occurs when the load of the core increases, which causes an increase in current draw by the core and voltage droop. As the transient suppressor circuit can respond faster to such droops than the primary power converter, the primary power converter can operate at a lower voltage (e.g., output a lower voltage) than it would normally operate to provide the same target supply voltage to the core as the primary power converter can rely on the transient power suppressor to mitigate the droops until the primary power converter can provide a higher voltage to the core. This lower operating voltage improves energy efficiency and the thermal output (e.g., less emanated heat) of the power supply system. The tighter margin between the primary power converter's output voltage and the target supply voltage can also enable the core to operate at a higher clock speed without increasing the thermal output of the system. For example, with the inclusion of the transient suppressor circuit, if the primary power converter outputs a 15% higher output voltage than required by the core, the core can use the higher voltage to operate at a higher clock speed rather than the 15% higher voltage being used as a tolerance for voltage droops. This increases the performance of the core by enabling the core to execute more instructions per unit time.

The transient suppressor circuit can be a modular addition to the same package as the core so that the physical space occupied by the core's power supply is not increased or is increased by only a small amount. The combination of space savings, energy efficiency, and improved thermal characteristics are important for mobile device implementations that have limited energy resources, sensitivity to high thermal outputs, and limited physical space. The physical space occupied by the power supply can be further reduced as the transient suppressor circuit allows for a reduction in the bulk capacitance on the power rails to the core.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B depict an example power supply system for a compute core.

FIG. 2 depicts an example layout of integrated circuits on a circuit board.

FIG. 3 depicts a graph of voltage and current measurements for a compute core power system.

FIG. 4 is a flow diagram of an example process for suppressing supply voltage differences.

Like reference numbers and designations in the various drawings indicate like elements.

### DETAILED DESCRIPTION

In general, this document describes power supply topologies for compute cores. The power supplies include a primary power converter that is configured to provide the primary DC power to the core via a power rail. The power supplies also include a transient suppressor circuit that is electrically coupled to the same power rail and that is configured to assist the primary power converter in regulating the power rail by suppressing transient voltage differences between the target supply voltage for the core and the actual input voltage to the core and regulating the rate of change in voltage on the power rail. Although the example power supply topologies are described in terms of regulating power to compute cores, the power supply topologies can be used in other applications where fast transient response is advantageous.

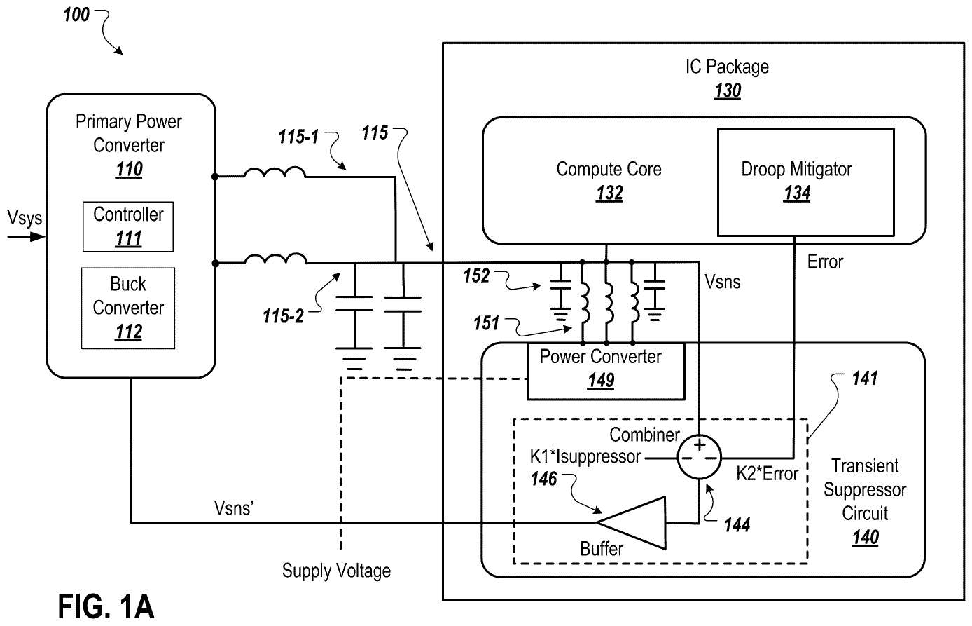

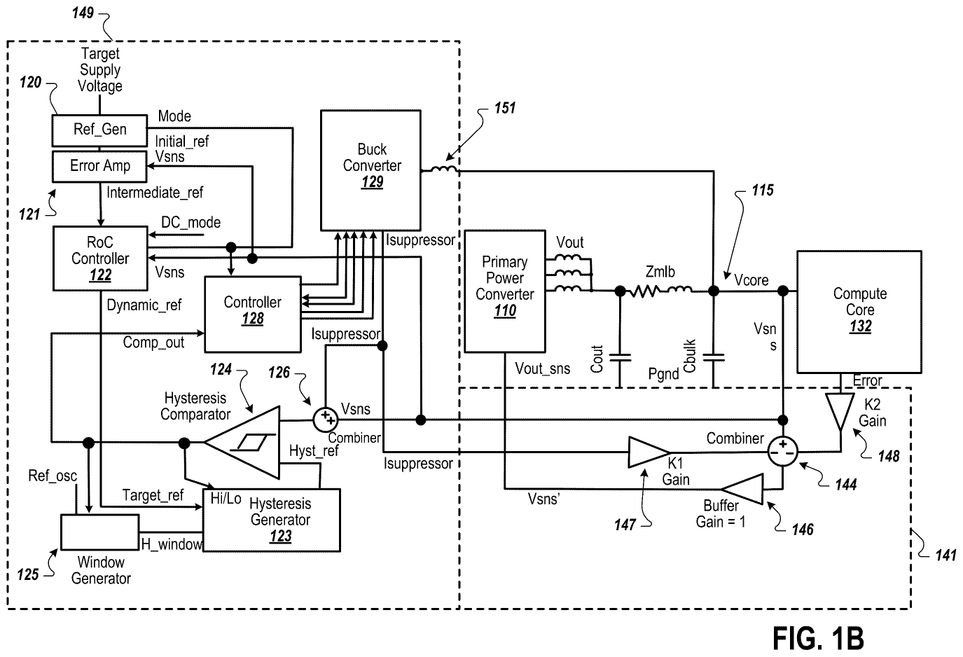

FIGS. 1A and 1B depict an example power supply system 100 for a compute core 132. In particular, FIG. 1B depicts components of an example implementation of a transient suppressor circuit 140 of the power supply system 100 in more detail.

Components of the power supply system 100 can be implemented using hardware and/or software. Hardware connections between components can be implemented using conductors, e.g., wires, traces, and so on.

Referring to FIG. 1A, the compute core 132 can include a processor core, such as a core of a central processing unit (CPU), a graphics processing unit (GPU), a tensor processing unit (TPU), another type of machine learning accelerator, a digital signal processing (DSP) unit, or another appropriate type of processing unit. The compute core 132 can be implemented in an integrated circuit (IC) of an IC package 130. Although only one core 132 is shown in FIG. 1, the IC package 130 can include multiple cores, e.g., in the form of a multi-core processor. Compute cores are also referred to as cores for brevity. The core 132 and its power supply system 100 can be part of a computing device, e.g., a notebook computer, desktop computer, tablet computer, smartphone, or other appropriate mobile or non-mobile computing device.

The core 132 includes a droop mitigator 134 that is configured to provide on-die droop mitigation by detecting when there is a voltage droop in the supply voltage to the core 132 and mitigating the effects of any detected voltage droop. For example, the core 132 can request that the primary power converter 110 provide a target supply voltage to the core 132 based on the workload that the core 132 is processing or about to process. If the actual supply voltage level drops below the target, e.g., due to the load of the core 132 drawing suddenly drawing additional current, the droop mitigator 134 can detect this voltage droop (e.g., by comparing a difference between the target and actual voltages to a threshold) and mitigate the effects of the voltage droop. For example, the core 132 can mitigate the effects by lowering its clock frequency or the number of instructions processed by the core 132 per unit time.

The power supply system 100 includes a primary power converter 110, a transient suppressor circuit 140, a power rail 115, and associated components, e.g., capacitors and inductors electrically coupled to the power rail 115. The primary power converter 110 is configured to provide the main DC power over the power rail 115 for powering the core 132. For example, the primary power converter 110 is configured to power the core 132 for all normal operating conditions for the core 132. In normal steady state operation, the primary power converter 110 provides all of the DC power used by the core 132.

The primary power converter 110 can be implemented in the form of a PMIC, which can be installed on or otherwise supported by the same printed circuit board at the IC package 130. The primary power converter 110 can include a DC-to-DC converter that converts an input DC supply (e.g., the Vsys) to voltage levels appropriate for the core 132, e.g., by stepping up and/or stepping down the voltage level. The supply voltage used by the core 132 can vary based on the load level (e.g., the number of instructions being processed per unit time and/or the operating frequency) of the core 132. For example, when the core 132 needs to process a large workload (e.g., a large number of instructions), the core 132 can request that the primary power converter 110 increase the supply voltage provided to the core 132 over the power rail 115. The higher voltage level enables the core 132 to operate at a higher clock frequency and therefore execute more instructions per unit time. When the core 132 is processing smaller workloads, the core 132 can request that the primary power converter 110 lowed the voltage level to reduce wasted energy and unnecessary thermal output. Thus, the primary power converter 132 can be configured to output DC supply voltage to the core 132 at different voltage levels.

The example primary power converter 110 includes a buck converter 112 that is configured to step down the voltage level for the core 132 and a controller 111 that is configured to control the buck converter 112. The main supply voltage of a computing device is often 12 VDC, while cores often operate at voltage levels at 5 VDC or less. The buck converters are switching converters that include one or more switches (e.g., semiconductor switches) that are operated (e.g., turned on and off) at particular frequencies to provide the desired DC voltage level at the output of the converter. In situations in which the voltage needs to be stepped up rather than stepped down, the buck converter 112 can be replaced with a boost converter or another appropriate type of converter based on the power requirements of the core 132 and the available power sources.

The controller 111 can operate the switch(es) of the buck converter 112 by sending control signals to the switches. The controller can adjust the switching signals (e.g., pulse width modulation (PWM) signals) based on an error between the target output voltage of the primary power converter 132 (which can be received from the core 132) and a voltage signal (Vsns). In general, this voltage signal Vsns represents the actual supply voltage at the core 132, but can be modified by the transient suppressor circuit 140, as described in more detail below. The buck converter 112 can include a gate driver that operates the switches based on the switching signals received from the controller 111.

In some implementations, the buck converter 112 is a multiphase converter. For example, the buck converter 112 is shown in FIG. 1 as a two-phase converter that outputs DC power at two different phases. The buck converter 112 can include a power stage for each phase and the power stage for each phase can include corresponding capacitors and/or inductors electrically coupled at the output of the power stage.

The transient suppressor circuit 140 assists the primary power converter 110 in regulating the power rail 115 for the core 132. The transient suppressor circuit 140 is configured to suppress transient voltage differences between the target supply voltage for the core 132 and the actual supply voltage to the core 132. The transient suppressor circuit 140 also regulates the rate of change of the supply voltage to the core 132, e.g., to reduce overshoots and undershoots and allow for tighter margins between the target supply voltage and the output voltage of the primary power converter 110. This also increases the speed at which transitions occur, as described above.

The transient suppressor circuit 140 includes a power converter 149 and a signal adjustment circuit 141. The power converter 149 is configured to regulate the voltage of the power rail 115 in certain situations, e.g., to compensate for transient voltage differences between the target supply voltage for the core 132 and the actual supply voltage to the core 132. As described in more detail with reference to FIG. 1B, the power converter 149 can include a hysteretic converter that operates in current mode to inject electrical charge onto or remove electrical charge from the power rail 115.

The power converter 149 can be configured to increase or decrease the voltage of the power rail 115 based on the rate of change of the actual supply voltage to the core 132. The voltage change can be caused by the primary converter 110 transitioning between target supply voltage levels or changes in the load level of the core 132. For example, if the actual supply voltage is increasing at a rate that exceeds a threshold, the power converter 149 can remove current from the power rail 115 to regulate the rate of change of the voltage and prevent or reduce the overshoot.

The power converter 149 is electrically coupled to the power rail 115 using one or more inductors 151. Each inductor 151 serves as an energy storage element for the power conversion performed by the power converter 149. The power rail 115 also includes decoupling capacitors 152 that serve as energy storage elements for the power conversion performed by power converter 149 and decouple the power converter 149 from the power rail 115. Although two decoupling capacitors 152 are shown in this example, any number of decoupling capacitors 152 can be used based on the application and target decoupling capacitance for the power supply system 100.

To adjust the voltage of the power rail 115, the power converter 115 can inject electrical charge into the decoupling capacitors 152 or remove electrical charge from the decoupling capacitors 152. For example, the power converter 115 can inject charge into the decoupling capacitors 152 to increase the voltage of the power rail 115 or remove charge from the decoupling capacitors 152 to reduce the voltage of the power rail 115.

Similar to the primary power converter 110, the power converter 149 can include a buck converter 128 and corresponding controller 129, as shown in FIG. 1B. This controller 129 can operate switches of the buck converter 128 to convert input DC power (e.g., Vsys) to a voltage level for injecting or removing electrical charge from the decoupling capacitors 152. When the transient suppressor circuit 140 removes electrical charge from the power rail 115, the transient suppressor circuit 140 can route the current to a battery of the computing device to charge the battery.

The buck converter 112 of the primary power converter 149 can have a higher efficiency than the buck converter 129 of the power converter 149. The buck converter 112 can also have a lower bandwidth than the buck converter 129. This configuration enables the primary power converter 110 to operate with high efficiency in steady state core conditions and enables the transient suppressor circuit 140 to quickly react to transient voltage differences between the target supply voltage and the actual supply voltage. For example, the buck converter 112 can have an efficiency of about 90% (e.g., between 85-95%) and a bandwidth of about one megahertz (MHz). In contrast, the buck converter 129 can have an efficiency of about 70% (e.g., between 65-75%) and a bandwidth between 10-50 MHz. As the transient suppressor circuit 140 is configured to react quickly to transient voltage differences and turn over voltage regulation to the primary power converter 110 when the primary power converter 110 is able to react to the voltage difference, the efficiency of the power converter 149 can be lower. In other words, the power converter 149 should be active for short periods of time only during transient excursions of the voltage level of the power rail 115 and the impact of the lower efficiency is negligible.

The signal adjustment circuit 141 is configured to selectively adjust a voltage signal Vsns that represents the actual supply voltage at the core 132. As described above, the primary power converter 110 can control its output voltage based on an error that represents a difference between the target supply voltage for the core and the actual supply voltage at the core 132 represented by the voltage signal Vsns. The signal adjustment circuit 141 can adjust this voltage signal Vsns to signal to the power converter 110 when either the transient suppressor circuit 140 or the droop mitigator 134 is performing mitigating operations based on the actual supply voltage to the core 132.

For example, the signal adjustment circuit 141 can lower the voltage signal Vsns when mitigating operations are being performed to cause the primary power converter 110 to increase its output voltage. In this example, the primary power converter 110 will compute a larger error between the target supply voltage and the actual supply voltage based on the reduction made by the signal adjustment circuit 141. In response, the primary power converter 110 will compensate for the higher error by raising its output voltage.

In another example, the signal adjustment circuit 141 can lower the voltage signal Vsns when the power converter 149 is removing electrical charge from the decoupling capacitors 115 based on the actual supply voltage being higher than the target supply voltage. In this example, the primary power converter 110 will compute a larger error between the target supply voltage and the actual supply voltage based on the increase made by the signal adjustment circuit 141. In response, the primary power converter 110 will compensate for the higher error by reducing its output voltage.

The signal adjustment circuit 141 includes a combiner 144, which can be implemented as a summation circuit, and a buffer 146. As shown in FIG. 1B and described below, implementations of the signal adjustment circuit 141 can include additional components. The buffer 146 isolates the output of the combiner 144 and the input of the primary converter 110.

The combiner 144 adjusts the voltage signal Vsns based on a current signal that represents the current supplied or removed from the power rail 115 by the transient suppressor circuit 140 (e.g., the output current of the power converter 149) and/or an error signal output by the droop mitigator 134. The transient suppressor circuit current is represented as “Isuppressor” and can be multiplied by a constant K1 before reaching an input of the combiner 144.

The error signal is represented as “Error” and can be multiplied by a constant K2 before reaching an input of the combiner 144. The error signal can have a value of zero when the droop mitigator 134 is not mitigating a droop and a positive value when the droop mitigator 134 is mitigating a droop. The error signal can represent a difference between the target clock frequency of the core 132 and an actual clock frequency of the core 132. Normally, the two clock frequencies are the same, but when the droop mitigator 134 is in active droop mitigation, the droop mitigator 134 can reduce the clock frequency, which increases the error signal. In other examples, the error signal can represent the magnitude of the voltage droop, a difference between a target number of instructions being executed by the core 132 per unit time and the number of instructions actually being performed by the core 132 per unit time, or an error signal generated by the droop mitigator 134 based on the level of mitigation being performed by the droop mitigator 134. The constants K1 and K2 can be used to normalize the current and can be tuned for various implementations of the power supply system 100. For example, the constants K1 and K2 can be programmable such that a user can set the values of the constants K1 and K2.

As shown in FIG. 1A, the polarity of the inputs to the combiner 144 for the current signal and the error signal are negative. The polarity of the input to the combiner of the voltage signal Vsns to the core is positive. This indicates that the current signal and the error signal are subtracted from the actual supply voltage. Thus, when the power converter 149 is injecting current onto the power rail 115, the combiner 144 subtracts a positive error signal from the voltage signal Vsns, thereby resulting in an adjusted voltage signal Vsns' that is lower than the voltage signal Vsns. This signal causes the primary power converter 110 to compute an error signal that indicates that the actual supply voltage is less than what is actually present on the power rail 115, causing the primary power converter 110 to compute a higher positive error and increase its output voltage. By increasing the output voltage based on this signal, the primary power converter 110 adapts quicker to a low rail voltage that is being mitigated by the transient suppressor circuit 140. When the primary power converter's output voltage is high enough, the transient suppressor circuit 140 can stop injecting current onto the power rail 115, which reduces or eliminates the difference between Vsns' and Vsns and the computed error. The combiner 144 and primary power converter 110 operate in a similar manner when the error signal is positive indicating that the droop mitigator 140 is actively mitigating.

When the power converter 149 is removing electrical charge from the decoupling capacitors 152, the combiner 144 subtracts a negative error signal from the voltage signal Vsns, thereby resulting in an adjusted voltage signal Vsns' that is higher than the voltage signal Vsns. This signal causes the primary power converter 110 to compute an error signal that indicates that the actual supply voltage is greater than what is actually present on the power rail 115, causing the primary power converter 110 to compute a higher negative error and reduce its output voltage. By reducing the output voltage based on this signal, the primary power converter 110 adapts quicker to a high rail voltage that is being mitigated by the transient suppressor circuit 140. When the primary power converter's output voltage is low enough, the transient suppressor circuit 140 can stop removing current onto the power rail 115, which reduces or eliminates the difference between Vsns' and Vsns and the computed error.

The magnitude of the current signal and the error signal can impact the error, which controls the magnitude of the adjustments made by the primary power converter 110 to its output voltage. For example, higher current signals indicate that the transient suppressor circuit 140 is injecting more current onto the power rail 115 than a lower current signal indicates. Thus, the transient suppressor circuit 140 is compensating for a greater voltage difference and the primary power converter 110 should increase its voltage to a higher level to compensate.

Referring to FIG. 1B, the signal adjustment circuit 141 can include the combiner 141, the buffer 146, a first gain circuit 147, and a second gain circuit 148. The first gain circuit 147 can apply a gain to the current signal Isuppressor and output the adjusted current signal to the combiner 144. For example, the first gain circuit 147 can multiply the current signal Isuppressor by a constant K1. The second gain circuit 148 can apply a gain to the error signal Error and output the adjusted error signal to the combiner 144.

For example, the second gain circuit 148 can multiply the error signal Error by a constant K2.

A voltage sensor can be electrically coupled to the input of the core 132 to detect the actual supply voltage (represented as Vcore) and provide the voltage signal Vsns to the combiner 144. Similarly, a current sensor can be electrically coupled to the output of the buck converter 129 to detect the current Isuppressor.

In this example, the power converter 149 is configured as a hysteretic converter with an addition of a rate of change controller 122 that regulates the rate of change of the voltage on the power rail 115 to supply the core 132. Other appropriate types of converters can also be used to regulate the voltage of the power rail 115, e.g., by injecting electrical charge onto and remove electrical charge from the decoupling capacitors 152 when the voltage difference between the target supply voltage and the actual supply voltage exceeds a threshold.

The power converter 149 includes a reference generator 120 and an error amplifier 121. The reference generator 120 generates an initial reference signal based on the target supply voltage for the core 132. The reference generator 120 can generate the reference signal by selectively adjusting or not adjusting the target supply voltage based on a mode of operation of the power converter 149. As described in more detail below, the rate of change controller 122 can select the mode for the transient suppressor circuit 140 based on the difference between the target supply voltage and the actual supply voltage to the core 132 and/or the rate of change of the actual supply voltage to the core 132. The modes can include an undershoot mode, an overshoot mode, and a disable mode.

In undershoot mode, the transient suppressor circuit 140 injects electrical charge into the decoupling capacitors 1520 reduce or prevent an undershoot of the target supply voltage (e.g., reduce the amount that the actual supply voltage drops below the target) and increase the speed at which the droop is corrected. In overshoot mode, the transient suppressor circuit 140 removes electrical charge from the decoupling capacitors 152 to reduce or prevent an overshoot of the target supply voltage (e.g., reduce the amount that the actual supply voltage goes above the target) and increase the speed at which the droop is corrected. In disable mode, the transient suppressor circuit 140 does not actively inject electrical charge onto or remove electrical charge from the decoupling capacitors 152.

In disable mode, the reference generator 120 does not modify the target supply voltage. Thus, the initial reference signal output by the reference generator 120 can equal the target supply voltage in disable mode. In overshoot mode, the reference generator 120 can generate the reference signal by applying a negative gain to the target supply voltage such that the reference signal is less than the target supply voltage. In undershoot mode, the reference generator 120 can generate the reference signal by applying a positive gain such that the reference signal is greater than the target supply voltage. These adjustments can be step-wise adjustments using step values to adjust the target supply voltage based on the mode.

The power converter 121 includes an error amplifier 121 that receives the initial reference signal from the reference generator 120 and the voltage signal Vsns that represents the actual supply voltage from the voltage sensor. The error amplifier 121 is configured to generate an intermediate reference signal based on the initial reference signal and the voltage signal Vsns. The error amplifier can execute a control loop to generate the intermediate reference signal to compensate for any residual regulation error imposed by the hysteretic control described below. In general, the hysteretic control can use current feedback to regulate the output voltage to the compute core 135. This can create a load line for which the error amplifier 121 compensates. The control loop of the error amplifier 121 can be slower than the hysteretic control loop. The rate of change controller 122 can compute the rate of change of the actual supply voltage to the core 132 using the voltage signal Vsns. The rate of change controller 122 can select the mode for the transient suppressor circuit 140 based on the computed rate of change. The rate of change controller 122 can compare the rate of change to one or more thresholds to select the mode. For example, if the rate of change satisfies a first threshold that has a positive value, e.g., by meeting or exceeding the first threshold, the rate of change controller 122 can select overshoot mode as a fast increase in the actual supply voltage indicates that an overshoot is possible or likely. If the rate of change satisfies a second threshold that has a negative value, e.g., by meeting or having a greater negative value than the second threshold, the rate of change controller 122 can select undershoot mode as a fast decrease in the actual supply voltage indicates that an undershoot is possible or likely. If the rate of change is between the first and second threshold, the rate of change controller 122 can select disable mode. In a particular example, the rate of change controller 122 can select overshoot more when the rate of change is greater than X millivolts (mV) per microsecond (μs), select undershoot mode when the rate of change is less than −X mV/μs (i.e., when the rate has a greater negative value than X), and select disable more when the rate of change is between X mV/μs and −X mV/μs, where X is any number.

The range of rates for the disable mode acts as a deadband that prevents the transient suppressor circuit 140 from injecting or removing electrical charge when there are small changes to the actual supply voltage. As these small changes may not affect the core 132, the primary power converter 110 can adjust its output voltage at a slower pace to correct the deviation. In addition, this prevents the transient suppressor circuit 140 from responding to normal ripples in the voltage.

The rate of change controller 122 provides a mode signal that indicates the mode to the reference generator 120 and to the controller 128 for the buck converter 129. The controller 128 can use the mode to generate the switching signals for switches of the buck converter 129, as described in more detail below.

The rate of change controller 122 also provides a dynamic reference signal to a hysteresis generator 123. The rate of change controller 122 can generate the dynamic reference signal by adjusting the intermediate reference signal received from the error amplifier 121 based on the rate of change of the actual supply voltage. For example, the rate of change controller 122 can generate the dynamic reference signal by reducing the reference when the transient suppressor circuit 140 is in undershoot mode. The rate of change controller 122 can also generate the dynamic reference signal by increasing the reference signal when the transient suppressor circuit 140 is in overshoot mode. This adjustment to the reference signal effectively shifts the hysteretic window used by the hysteresis comparator 124 to determine when to cause the controller 128 to operate the switches of the buck converter 129 to inject electrical charge on or remove electrical charge from the decoupling capacitors 152.

In some implementations, the rate of change controller 122 is deactivated when the primary power converter 110 is transitioning between voltage levels, e.g., during DVS transitions. A power manager can output a DC_mode signal that is routed to the transient suppressor circuit 140, which in turn provides the DC_mode signal to the rate of change controller 122. This DC_mode signal can indicate when a transition is in progress, which instructs the transient suppressor circuit 140 to operate in a DC mode such that the control of the power converter 149 operates as a buck converter rather than a hysteretic converter. In this DC mode, the rate of change controller 122 may pass the intermediate reference signal as the dynamic reference signal without any adjustment to the intermediate reference signal. This prevents the rate of change controller 122 from slowing the transition.

In general, the hysteresis generator 123, window generator 125, and hysteresis comparator 124 are configured to use hysteresis to inject or remove electrical charge when there is a sufficiently large deviation between the target supply voltage and the actual supply voltage. When the target output moves at a given rate, the hysteretic window moves at the same rate. In this way, the hysteretic window can limit the rate of change of the actual supply voltage to the core 132.

The hysteresis generator 123 generates a hysteresis reference for the hysteresis comparator 124 based on the target reference received from the rate of change controller 122 and a hysteresis window generated by a hysteresis window generator 125. The hysteresis window generator 125 generates the hysteresis window based on a reference clock signal “Ref_osc” and the frequency of the output of the hysteresis comparator 124, which can be implemented using a frequency locked loop (FLL). The window generator 125 can attempt to adjust the comparator frequency to match the reference clock by shifting the hysteresis window. In some implementations, the window generator 125 generates the hysteresis window using a static value by adding the static value to the dynamic reference signal output by the rate of change controller 122 to get the high value of the window and subtracting the static value from the dynamic reference signal output by the rate of change controller 122 to get the low value of the window. The hysteresis window represents the operating frequency for the buck converter 129. A larger hysteresis window provides a lower operating frequency.

The hysteresis generator 123 outputs, as the hysteresis reference signal, either the high value of the hysteresis window or the low value of the hysteresis window depending on the input value “Hi/Lo” received from the output of the hysteresis comparator 124. The hysteresis comparator 124 compares a sum of the current output by the converter 129 Isuppressor and the voltage signal Vsns (output by combiner 126) to the hysteresis reference. In some implementations, this current Isuppressor can be scaled using a gain before being added to the voltage signal Vsns.

If the sum is greater than the hysteresis reference, the hysteresis comparator generates a comparator output “Comp_out” that represents a high signal. If the sum is less than the hysteresis reference, the hysteresis comparator generates a comparator output that represents a low signal.

The hysteresis generator 123 can be configured to output the low value of the hysteresis window as the hysteresis reference when the comparator output is high to move the output of the converter 129 lower. Similarly, the hysteresis generator 123 can be configured to output the high value of the hysteresis window as the hysteresis reference when the comparator output is low to move the output of the converter 129 higher.

The comparator output is also routed to the input of the controller 128. The controller 128 uses the comparator output from the hysteresis comparator 124 and the mode of the transient suppressor circuit 140 to generate switching signals (e.g., PWM signals) for the switches of the buck converter 129. In general, the duty cycle of the hysteresis comparator 124 is the duty cycle of the switches of the buck converter 129. When the comparator output is high, the controller 128 can close the high side switches of the buck converter 129 and open the low side switches of the buck converter 129. When the comparator output 124 is low, the controller 128 can open the high side switches of the buck converter 129 and close the low side switches of the buck converter 129.

The mode signal drives how the controller 128 operates the switches of the buck converter 128. For example, when the mode is overshoot or undershoot, the controller 128 can operate the switches according to the duty cycle of the comparator output. If the mode is disabled, there would be no hysteresis window and the controller 128 can control the switches as a normal buck converter by adjusting the duty cycle of the switches to increase or decrease the output voltage to meet the target supply voltage.

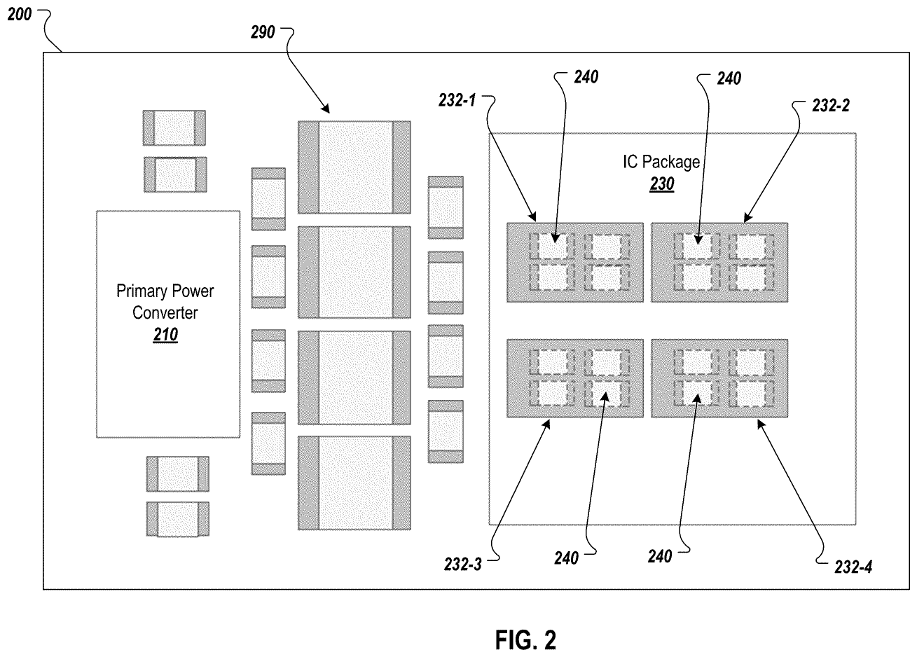

FIG. 2 depicts an example layout of integrated circuits on a circuit board 200. The circuit board 200 includes a primary power converter 210, an IC package 230, and additional components 290 arranged between the primary power converter 210 and the IC package. The primary power converter 210 can be implemented using the primary power converter 110 of FIGS. 1A and 1B or another appropriate type of power converter. The additional components 290 can include other ICs, resistors, capacitors, inductors, etc.

The IC package 230 includes processing units 231 (i.e., 231-1 to 231-4) and transient suppressor circuits 240. The processing units 331 can be CPUs, GPUs, TPUs, DSPs, and/or other appropriate types of processing units. In this example, each processing unit 231 includes four cores (not shown) and the IC package 230 includes a transient suppressor circuit 240 for each core. Other numbers of processing units and cores per processing unit can also be used. Each transient suppressor circuit 240 can be implemented using the transient suppressor circuit 140 of FIG. 1.

In general, the transient suppressor circuit 240 for a core can be located close to the core to reduce the parasitics of the electrical coupling between the transient suppressor circuit and the power rail for the core. For example, the transient suppressor circuit 240 for a core can be located within 10 millimeters (mm) of the physical circuit of the core. In contrast, the primary power converter 310 can be further from the cores, e.g., an inch or further from each core. In addition to reducing parasitics, the proximate location enables faster response to transients and rapid changes in the supply voltage to the core.

Due to the proximate location and the high frequency operation of the transient suppressor circuit 240, a very small amount of inductance can be used between the transient suppressor circuit 240 and the power rail. For example, this inductance can be about 10-20 nanohenries (nHs) or even less, which can be implemented using an air core loop of wire rather than a typical inductor.

The transient suppressor circuit 240 for a core can be located adjacent to the core, above the core, below the core, or otherwise near the core. For example, the transient suppressor circuit 240 for a core can be embedded in the substrate below the core. The transient suppressor circuit 240 can be included in the IC package 230 or separate from the IC package 230.

Each transient suppressor circuit 240 can be electrically coupled to a respective power rail that electrically couples the primary power converter 210 to one or more cores of the IC package 230. For example, the primary power converter 210 can be configured to provide power to multiple rails between the primary power converter and the IC package 230, e.g., one per core or one per groups of cores. This electrical coupling enables the transient suppressor circuit 240 to inject electrical charge onto and/or remove electrical charge from the decoupling capacitors 152.

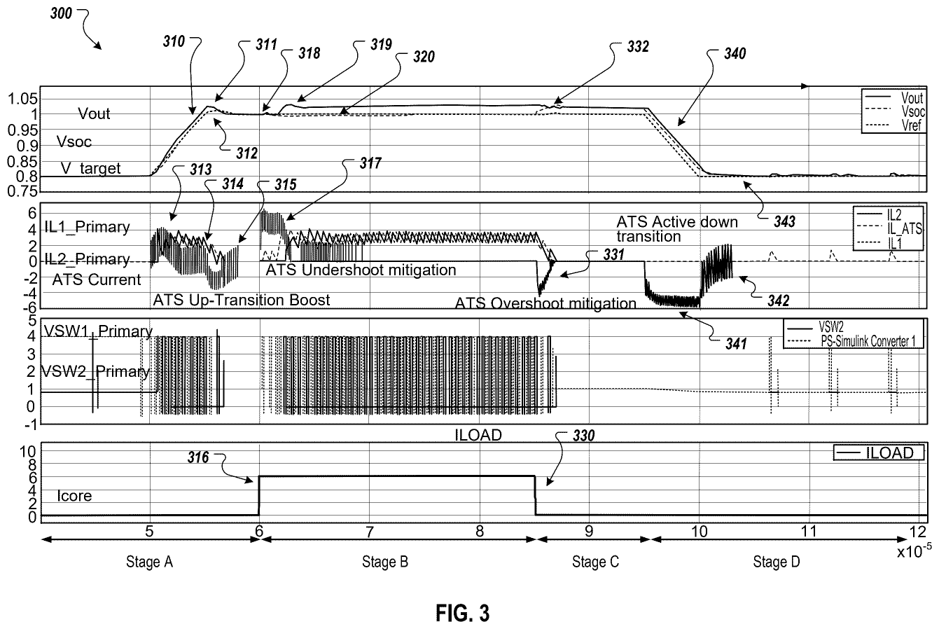

FIG. 3 depicts a graph 300 of voltage and current measurements for an example compute core power system. The graph illustrates changes in the target supply voltage for the core 132, the output voltage of the primary power converter 110, the actual supply voltage to the core 132, the current of the primary power converter 110, the current output by the transient suppressor circuit 140, and the current draw of the core 132.

In stage A, the target supply voltage is transitioned from a low voltage state to a high voltage state for the core 132. This transition can be a DVS transition in anticipation of a workload that is processed in stage B. When the target supply voltage increases as shown at reference numeral 310, the output voltage of the primary power converter increases at a similar rate as the rate at which the target supply voltage increases. However, the output voltage of the primary power converter 110 overshoots the target supply voltage by a small amount prior to settling at or near the target supply voltage, as shown at reference numeral 311.

During the transition, the transient suppressor circuit 140 injects current onto the power rail 115 to regulate the rate at which the actual supply voltage to the core 132 increases until the overshoot occurs as shown at reference numeral 313. To reduce or prevent the overshoot from causing a similar overshoot at the core 132, the transient suppressor circuit 140 removes electrical charge from the power rail 115 as shown at reference numeral 314. As shown at reference numeral 312, the difference between the target supply voltage and the actual supply voltage is smaller than the difference between the output voltage of the primary power converter 110 and the target supply voltage. Absent the transient suppressor circuit 140, this difference could be around 50 mV or even higher due to the overshoot of the primary power converter 110.

As shown at reference numeral 315, the transient suppressor circuit 140 injects current for a brief period of time until the primary power converter 110 reaches an output voltage level that provides an actual supply voltage level at the core 132 that matches or is within a tolerance range of the target supply voltage level. When the changes in the actual supply voltage are low, e.g., less than a threshold, the transient suppressor circuit 140 can stop injecting or removing electrical charge.

In stage B, the core 132 increases its current draw from the power rail 132, as shown at reference numeral 316. This would typically result in a droop in the actual supply voltage at the core 132 while waiting for the primary power converter 110 to increase its voltage to compensate for the additional current draw. To reduce prevent such droop, the transient suppressor circuit 140 injects current onto the power rail 115, as shown at reference numeral 317, providing undershoot mitigation. A short time after the increased current draw begins and the transient suppressor circuit 140 injects the current, the output voltage of the primary power converter 110 increases as shown between reference numerals 318 and 319. As the primary power converter's output voltage increases, the transient suppressor circuit 140 can reduce the amount of current that it injects onto the power rail 115. As shown in stage B, the actual supply voltage closely tracks the target supply voltage due to the undershoot mitigation provided by the transient suppressor circuit 140.

In stage C, core 132 reduces its current draw from the power rail 132, as shown at reference numeral 330. This typically results in an increased voltage at the core 132. To reduce or prevent such increase, the transient suppressor circuit 140 removes electrical charge from the power rail 115, as shown at reference numeral 331.

In stage D, the target supply voltage is transitioned from a high voltage state to a low voltage state for the core 132. This transition can be a DVS transition after the workload is processed in stage B. When the target supply voltage decreases as shown at reference numeral 340, the output voltage of the primary power converter decreases at a similar rate as the rate at which the target supply voltage decreases.

During the transition, the transient suppressor circuit 140 removes electrical charge from the power rail 115 to regulate the rate at which the actual supply voltage to the core 132 decreases as shown at reference numeral 341. To reduce or prevent the undershoot by the primary power converter 110 from causing a similar undershoot at the core 132, the transient suppressor circuit 140 injects current from the power rail 115 as shown at reference numeral 342. As shown at reference numeral 343, the actual supply voltage closely tracks the target supply voltage without any significant undershoot. Absent the transient suppressor circuit 140, the actual supply voltage would drop below the target supply voltage until the primary power converter 110 is able to compensate.

The graph 300 illustrates how the quick reaction of the transient suppressor circuit 140 can work for short periods of time to prevent significant excursions from the target supply voltage, while allowing the primary power converter 110 to provide the primary voltage to the core 132.

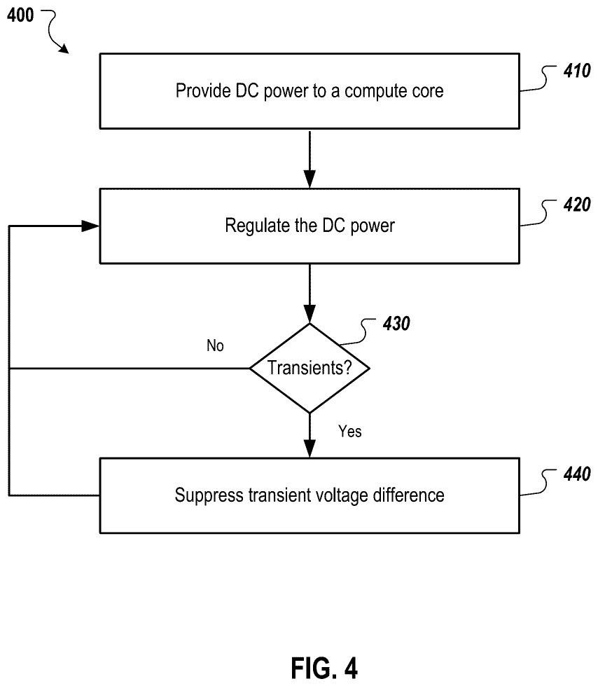

FIG. 4 is a flow diagram of an example process 400 for suppressing supply voltage differences. The process 400 can be performed by a power supply system, e.g., the power supply system 100 of FIGS. 1A and 1B.

A primary power converter 110 of the power supply system 100 provides DC power to a computer core (410). The primary power converter 110 can provide the DC power to the compute core over a power rail that electrically couples the primary power converter to the compute core.

The primary power converter 110 regulates the DC power provided to the compute core (420). For example, the primary power converter 110 can regulate the DC voltage and/or current levels of the power rail. As described above, the primary power converter 110 can use closed loop control along with a buck converter to regulate the DC power. For example, the primary power converter 110 can receive a target voltage level for supplying the compute core and regulate the power rail to maintain that voltage level on the power rail.

A transient suppressor circuit 140 of the power supply system 100 is configured to detect transient differences between the target voltage level for the compute core and the actual voltage level of the power rail. For example, the transient suppressor circuit 140 can be configured to detect voltage differences and/or rates of change of the actual voltage level of the power rail. The transient suppressor circuit 140 can determine whether a transient is present based on the voltage differences and/or rates of change (430). For example, the transient suppressor circuit can determine that a transient is present when the voltage difference and/or the rate of change satisfy respective thresholds.

If a transient voltage difference is detected, the transient suppressor circuit 140 can mitigate the voltage difference (440). As described above, the transient suppressor circuit 140 includes a control loop and power converter that selectively inject or remove charge from one or more capacitors coupled to the power rail whenever a transient is detected.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A power supply system for a compute core, comprising:
a primary power converter configured to provide and regulate direct current (DC) power to the compute core over a power rail that electrically couples an output of the primary power converter to the compute core; and
a transient suppressor circuit coupled to the power rail and configured to suppress transient voltage differences between a target supply voltage for the compute core and an actual supply voltage to the compute core.

2. The power supply system of claim 1, wherein the transient suppressor circuit comprises an additional power converter configured to selectively inject electrical charge onto one or more capacitors coupled to the power rail based on the transient voltage differences.

3. The power supply system of claim 2, wherein the transient suppressor circuit comprises a hysteretic control loop comprising a rate of change controller that regulates a rate of change of the actual supply voltage to the compute core.

4. The power supply system of claim 3, wherein the rate of charge controller comprises multiple modes including a disable mode in which the rate of change controller is disabled when the primary power converter is actively increasing or decreasing the actual supply voltage based on a workload of the compute core.

5. The power supply system of claim 2, wherein the power converter comprises a buck converter.

6. The power supply system of claim 1, wherein the transient suppressor circuit comprises a signal adjustment circuit configured to adjust a voltage signal that represents the actual supply voltage and provide the adjusted voltage signal to the primary power converter.

7. The power supply system of claim 6, wherein the primary power converter is configured to adjust the DC power to the compute core based on an error that represents a difference between the target supply voltage and the adjusted voltage signal.

8. The power supply system of claim 6, wherein the transient suppressor circuit comprises a combiner circuit configured to generate the adjusted voltage signal based an output current of the transient suppressor circuit injected onto or removed from the power rail by the transient suppressor circuit.

9. The power supply system of claim 6, wherein the transient suppressor circuit comprises a combiner circuit configured to generate the adjusted voltage signal based on an error signal received from the compute core.

10. The power supply system of claim 9, wherein the error signal indicates whether a droop mitigator of the compute core is mitigating a voltage droop of the compute core.

11. The power supply system of claim 1, wherein the transient suppressor circuit is physically located closer to the compute core than the primary power converter.

12. The power supply system of claim 1, wherein a control loop of the transient suppressor circuit is faster and has a higher bandwidth than a control loop of the primary power converter.

13. A method for regulating power to a compute core, the method comprising:
providing, by a primary converter, direct current (DC) power to the power core over a power rail that electrically couples an output of the primary power converter to the compute core;
regulating, by the primary power converter, a voltage level of the power rail;
detecting, by a transient suppressor circuit electrically couple to the power rail, a transient voltage difference between a target supply voltage for the compute core and the voltage level of the power rail; and
selectively adjusting, by the transient suppressor circuit, the voltage level of the power rail by injecting electrical charge or removing electrical charge from one or more capacitors electrically coupled to the power rail.

14. The method of claim 13, wherein detecting the transient voltage difference comprises:
detecting, by a rate of change controller of the transient suppressor circuit, a rate of change of the voltage level of the power rail; and
determining that the rate of charge satisfies a threshold rate of change.

15. The method of claim 14, further comprising:
receiving a mode signal indicating that the primary power converter is actively increasing or decreasing the actual supply voltage based on a workload of the compute core; and
disabling the rate of change controller in response to receiving the mode signal.

16. The method of claim 13, further comprising:
adjusting, by a signal adjustment circuit of the transient suppressor circuit, a voltage signal that represents the actual supply voltage; and
providing, by the signal adjustment circuit, the adjusted voltage signal to the primary power converter.

17. The method of claim 16, further comprising adjusting, by the primary power converter, the DC power to the compute core based on an error that represents a difference between the target supply voltage and the adjusted voltage signal.

18. The method of claim 16, further comprising generating, by a combiner circuit of the transient suppressor circuit, the adjusted voltage signal based an output current of the transient suppressor circuit injected onto or removed from the power rail by the transient suppressor circuit.

19. The method of claim 16, further comprising generating, by a combiner circuit of the transient suppressor circuit, the adjusted voltage signal based on an error signal received from the compute core.

20. The method of claim 19, wherein the error signal indicates whether a droop mitigator of the compute core is mitigating a voltage droop of the compute core.
